(19) United States
(12) Patent Application Publication
(10) Pub. No.: US 2025/0333274 A1
(43) Pub. Date: Oct. 30, 2025

(54) POSTURE CORRECTION APPARATUS

(71) Applicant: Isuzu Motors Limited, Yokohama-shi (JP)

(72) Inventor: Muneyuki OSAWA, Fujisawa-shi (JP)

(73) Assignee: Isuzu Motors Limited, Yokohama-shi (JP)

(21) Appl. No.: 19/056,998

(22) Filed: Feb. 19, 2025

(30) Foreign Application Priority Data
Apr. 25, 2024 (JP) 2024-071326

(51) Int. Cl. B66F 7/28; B60L 53/80

(52) U.S. Cl. CPC B66F 7/28; B60L 53/80

(57) ABSTRACT

A posture correction apparatus includes: a plurality of correction units corresponding to a plurality of wheels of a vehicle; and a control apparatus that controls the correction units, wherein the correction units includes a conveyor that moves a corresponding wheel in a left-right direction of the vehicle, and a lifter that moves the conveyor in an up-down direction, and the control apparatus independently controls at least an operation of the lifter 20 of each correction unit.

### CROSS REFERENCE TO RELATED APPLICATIONS

This application claims the benefit of priority of Japanese Patent Application No. 2024-071326, filed on Apr. 25, 2024, the contents of which are incorporated by reference as if fully set forth herein in their entirety.

### TECHNICAL FIELD

The present disclosure relates to a posture correction apparatus.

### BACKGROUND ART

Conventionally, an apparatus for correcting the posture of a parked vehicle at a battery exchange station is known. For example, PTL 1 discloses an apparatus that corrects the yaw angle by pushing the wheel from the inside to the outside and corrects the roll angle and the pitch angle by lifting the bottom surface of the vehicle body upward.

### CITATION LIST

### Patent Literature

PTL 1
Japanese Patent Application Laid-Open No. 2012-6591

### SUMMARY OF INVENTION

### Technical Problem

However, the apparatus disclosed in PTL 1 is designed for passenger vehicles, which presents the problem of being limited to specific vehicle types.

An object of an aspect of the present disclosure is to provide a posture correction apparatus that can be used for a wider range of vehicle types.

### Solution to Problem

A posture correction apparatus according to an aspect of the present disclosure includes a plurality of correction units corresponding to a plurality of wheels of a vehicle; and a control apparatus that controls the correction units. The correction units includes: a conveyor that moves a corresponding wheel in a left-right direction of the vehicle, and a lifter that moves the conveyor in an up-down direction, and the control apparatus independently controls at least an operation of the lifter of each correction unit.

### Advantageous Effects of Invention

According to the present disclosure, a wider range of vehicle types can be supported.

### BRIEF DESCRIPTION OF DRAWINGS

FIG. 1 is a top view of a battery exchange station;

FIG. 2 is a first perspective view illustrating a correction unit;

FIG. 3 is a second perspective view illustrating the correction unit;

FIG. 4 is a third perspective view illustrating the correction unit;

FIG. 5A is a top view schematically illustrating a vehicle before yaw angle correction;

FIG. 5B is a top view schematically illustrating a vehicle after yaw angle correction;

FIG. 6A is a side view schematically illustrating a vehicle before pitch angle correction;

FIG. 6B is a side view schematically illustrating a vehicle after pitch angle correction; and

FIG. 7 is a block diagram illustrating an exemplary configuration of a control apparatus.

### DESCRIPTION OF EMBODIMENTS

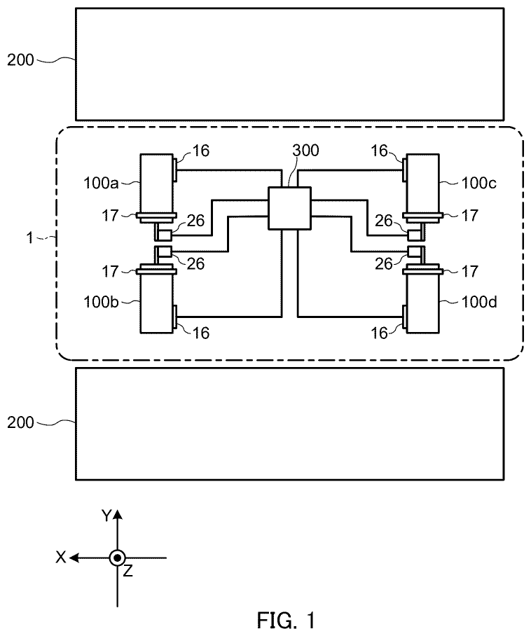

Hereinafter, posture correction apparatus 1 according to an embodiment of the present disclosure will be described with reference to FIGS. 1 to 7.

Posture correction apparatus 1 described below is a system for correcting the posture (specifically, the yaw angle, the roll angle, and the pitch angle) of a parked vehicle. Posture correction apparatus 1 includes a plurality of correction units corresponding to a plurality of wheels of a vehicle, and a control apparatus that controls each of the plurality of correction units. In the present specification, a vehicle is an automobile equipped with a plurality of wheels, and includes not only passenger vehicles but also commercial vehicles.

FIG. 1 is a top view of a battery exchange station. Posture correction apparatus 1 is installed in a battery exchange station for performing the exchange of a battery mounted on a vehicle, for example. The battery exchange station is a facility that includes posture correction apparatus 1 and exchange apparatus 200 for performing battery exchange. Exchange apparatus 200 is an apparatus that automatically performs an operation of removing a battery from a vehicle parked in its vicinity and attaching a new battery to the vehicle. Posture correction apparatus 1 includes a plurality of correction units 100a to 100d corresponding to a plurality of wheels of a vehicle, and control apparatus 300.

Since correction units 100a to 100d have the same structure, the correction units are referred to as correction unit 100 for description of a common mechanism and control of the correction units, and the correction units are referred to as correction units 100a to 100d for description of respective individual mechanisms and controls. Note that motor 16, motor 26, and bar 17 are each the structural element of correction unit 100, and will be described later.

The plurality of correction units 100a to 100d are provided corresponding to the positions of respective wheels at the parking position of the vehicle. The vehicle is parked such that one wheel is placed on one correction unit 100. Thus, one correction unit 100 is disposed under each of the plurality of wheels of the parked vehicle. In the present specification, for convenience, a double tire (also referred to as a twin tire or a dual tire) as well as a single tire will be treated as “one wheel.”

In FIG. 1, the left-right direction of the paper surface (X direction) corresponds to the front-rear direction of the station or the vehicle. Further, a direction (Y direction) perpendicular to the paper surface corresponds to the left-right direction of the station or the vehicle. Note that in a case where the vehicle enters the battery exchange station obliquely, these directions do not exactly coincide.

In the present embodiment, correction unit 100 provided on the front right side in the X direction in FIG. 1 will be referred to as correction unit 100a. Correction unit 100a corresponds to the wheel on the front right side of the vehicle. Similarly, correction unit 100 provided on the front left side will be referred to as correction unit 100b. Correction unit 100b corresponds to the wheel on the front left side of the vehicle. Correction unit 100 provided on the rear right side will be referred to as correction unit 100c. Correction unit 100c corresponds to the wheel on the rear right side of the vehicle. Correction unit 100 provided on the rear left side will be referred to as correction unit 100d. Correction unit 100d corresponds to the wheel on the rear left side of the vehicle.

Control apparatus 300 is a control apparatus that independently controls each correction unit 100. Control apparatus 300 controls at least lifter 20 of each correction unit 100 independently. Control apparatus 300 is capable of correcting the inclination, in the pitch direction and the roll direction, of the vehicle placed on conveyor 10 of correction unit 100, by controlling at least lifter 20 of each correction unit 100 independently. Control apparatus 300 controls motor 16 and motor 26 of each correction unit 100 to control correction unit 100.

Exchange apparatus 200 is an apparatus that automatically performs an operation of removing a battery from a vehicle parked in its vicinity and attaching a new battery to the vehicle.

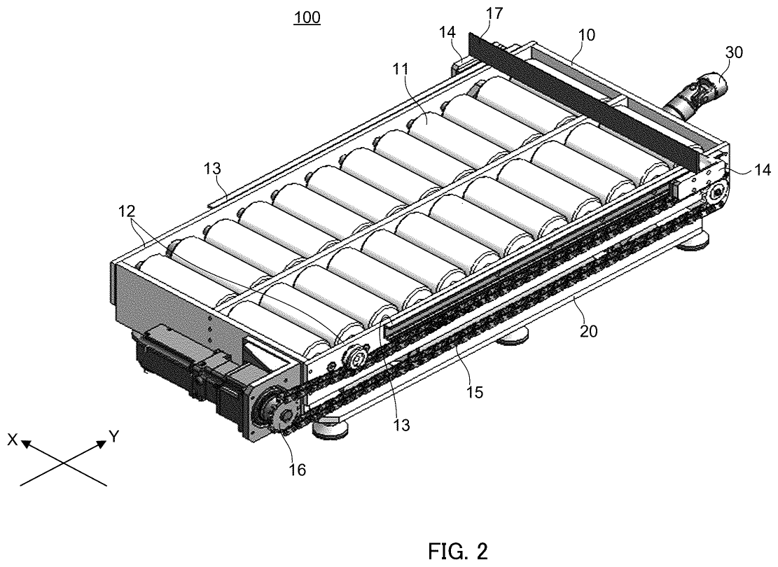

Next, the structure of correction unit 100 will be described. FIG. 2 is a top perspective view illustrating correction unit 100. Correction unit 100 illustrated in FIG. 2 is correction unit 100b, for example. Correction unit 100 includes conveyor 10 and lifter 20. Conveyor 10 is an apparatus that moves the corresponding wheel in the left-right direction of the vehicle. Conveyor 10 is an apparatus that corrects the inclination (yaw angle) of the vehicle in the yaw direction by moving the corresponding wheel in the left-right direction of the vehicle. Lifter 20 is an apparatus that moves conveyor 10 in the up-down direction. Lifter 20 is an apparatus that lifts conveyor 10 and corrects the up-down direction of the wheels of the corresponding vehicle.

Conveyor 10 includes a plurality of rollers 11, side surface member 12, linear motion guide 13, moving member 14, chain 15, motor 16, and bar 17.

The plurality of rollers 11 are disposed to rotate in the left-right direction (Y direction) of the battery exchange station. In the present embodiment, the plurality of rollers are disposed in two rows in parallel. Each roller 11 rotates around rotation shaft 2a provided along the front-rear direction (X direction) of the battery exchange station.

Side surface member 12 is a plate-like member that constitutes a side surface of conveyor 10. Linear motion guide 13 is provided on the outer surface of side surface member 12. Linear motion guide 13 is a rail member having a linear shape along the Y direction.

Moving member 14 is a substantially rectangular parallelepiped member, and is provided to be movable along the Y direction on linear motion guide 13. Moving member 14 is fixed to each of chain 15 and bar 17.

Chain 15 is an endless member wound around each of motor 16 and a sprocket (reference number omitted), and rotates by receiving the rotational force of motor 16. The operation of motor 16 is controlled by control apparatus 300, which will be described later. Motor 16 corresponds to an example of the first motor.

Bar 17 is a long member that extends along the X direction. Bar 17 is provided to be movable along Y direction 0 on the upper side of conveyor 10 (specifically, on the plurality of rollers 11). Bar 17 is a pushing member that moves on roller 11 in conjunction with moving member 14 to push the wheel placed on conveyor 10 along the Y direction.

The positions of bar 17 and moving member 14 illustrated in FIG. 2 are positions before the start of the movement (hereinafter, referred to as standby positions). When chain 15 rotates counterclockwise by the driving of motor 16 with bar 17 and moving member 14 located at the standby position, moving member 14 fixed to chain 15 moves on linear motion guide 13 in the Y direction. In conjunction with the movement of moving member 14, bar 17, which is fixed to moving member 14, also moves on the plurality of rollers 11 toward motor 16. In a case where a wheel is placed on conveyor 10, the wheel is pushed by moved bar 17 so as to move along the Y direction. By moving the wheel in the Y direction, it is possible to correct the inclination of the vehicle in the yaw direction.

Note that bar 17 that has moved toward motor 16 can be returned to the standby position illustrated in FIG. 2 by rotating chain 15 clockwise by driving motor 16. In this manner, bar 17 moves toward power input shaft 30 described later and returns to the standby position.

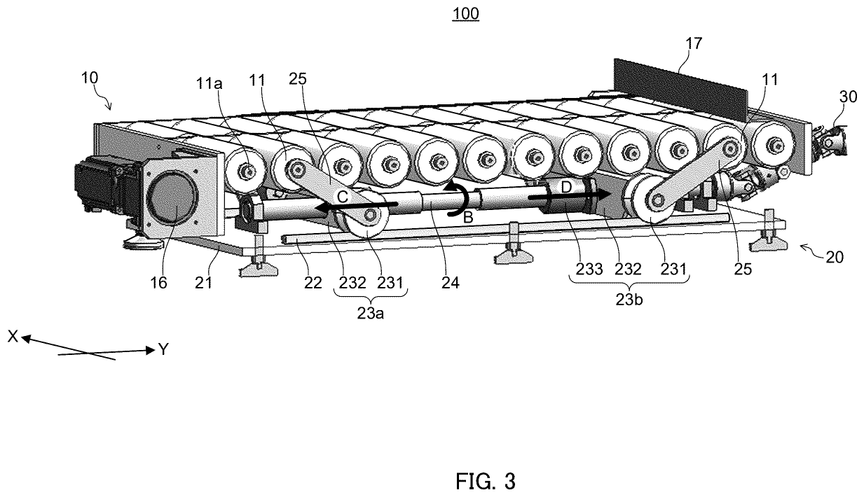

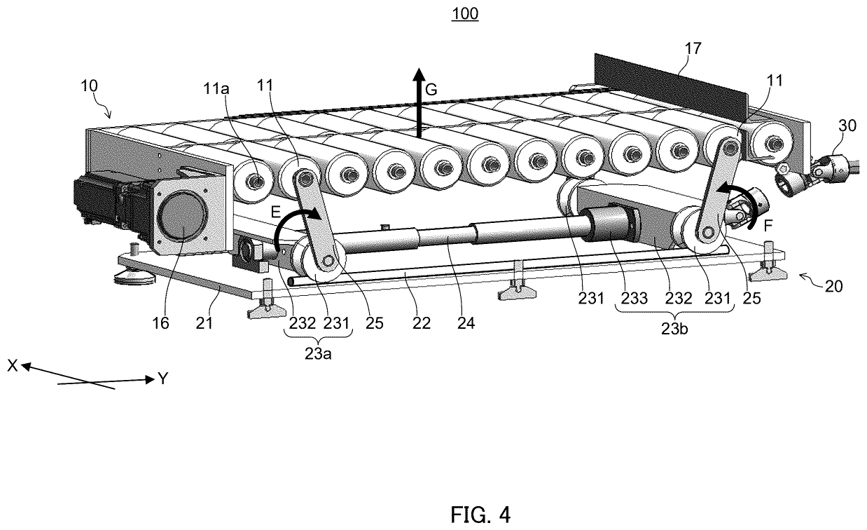

Next, lifter 20, which is a means for correcting the inclination (roll angle and pitch angle) of the vehicle in the roll direction and the pitch direction in correction unit 100 will be described with reference to FIGS. 3 and 4. FIGS. 3 and 4 illustrate a state in which one of side surface member 12 (side surface member 12 on the side where chain 15 is provided) illustrated in FIG. 2 is removed.

Lifter 20 includes bottom surface member 21, linear motion guide 22, first moving member 23a, second moving member 23b, screw member 24, and link 25. Further, lifter 20 includes motor 26.

Note that although not visible in FIGS. 3 and 4, linear motion guide 22, first moving member 23a, second moving member 23b, and link 25 are also provided on the depth side in the drawings (the side surface member 12 side on which chain 15 is not provided in FIG. 1) in the same manner.

Bottom surface member 21 is a plate-like member disposed below the plurality of rollers 11. Linear motion guide 22 is provided on the upper surface of bottom surface member 21. Linear motion guide 22 is a rail member having a linear shape along the Y direction.

First moving member 23a and second moving member 23b are members that are movable along the Y direction. First moving member 23a and second moving member 23b each include wheel part 231, support part 232, and nut part 233.

Wheel part 231 is provided to be movable on linear motion guide 22 while rotating along the Y direction.

Support part 232 is a member that supports wheel part 231 and nut part 233. Support part 232 is provided with one nut part 233 and two wheel parts 231 (see FIG. 3).

Nut part 233 is a cylindrical member into which an end of screw member 24 is inserted. A female screw is provided in the inner peripheral surface of nut part 233.

Screw member 24 is a rod-like member, and a male screw is provided on the outer peripheral surface at both ends thereof. The male screws at both ends are screwed into the female screw of nut part 233 of first moving member 23a and the female screw of nut part 233 of second moving member 23b.

When power (details will be described later) is transmitted from power input shaft 30, screw member 24 rotates in the direction of arrow B illustrated in FIG. 2, and moves first moving member 23a in the direction of arrow C and second moving member 23b in the direction of arrow D by the screwing action between the female screw and the male screw.

Link 25 is a plate-like member that connects wheel part 231 and roller 11.

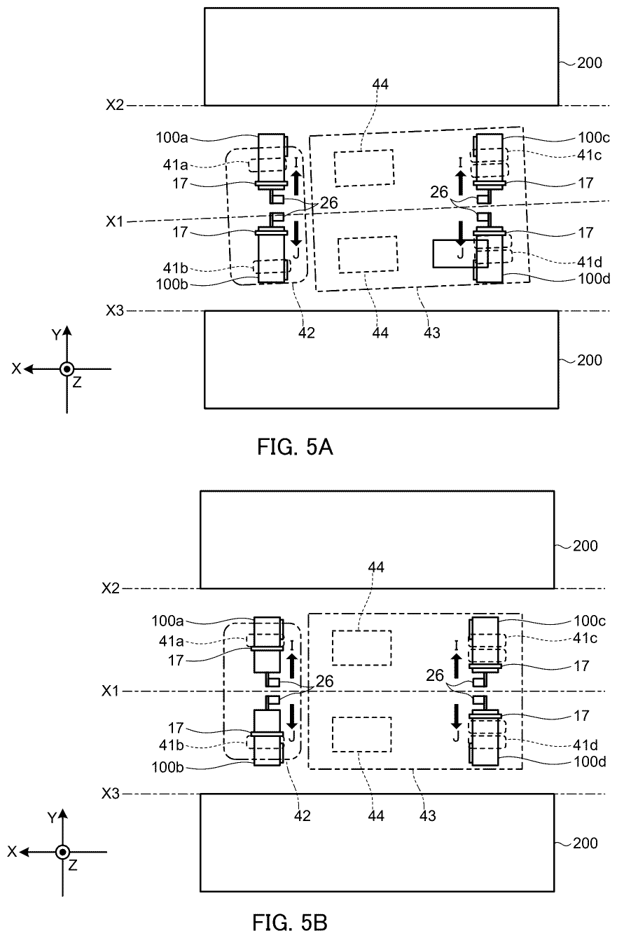

Power input shaft 30 is a shaft to which power from motor 26 (see FIGS. 4, 5A, and 5B) described later is input. Power input shaft 30 is connected to screw member 24. Thus, the power from motor 26 is transmitted to screw member 24 via power input shaft 30.

The positions of conveyor 10, first moving member 23a, and second moving member 23b illustrated in FIG. 3 are positions before the start of the movement (hereinafter, referred to as standby positions). When power is input to power input shaft 30 by driving motor 26 with first moving member 23a and second moving member 23b located at the standby position, screw member 24 to which the power has been transmitted rotates in the direction of arrow B illustrated in FIG. 3. Along with this rotation, first moving member 23a moves in the direction of arrow C illustrated in FIG. 3, and second moving member 23b moves in the direction of arrow D illustrated in FIG. 3. Along with this movement, link 25 of first moving member 23a rotates in the direction of arrow E illustrated in FIG. 4, and link 25 of second moving member 23b rotates in the direction of arrow F illustrated in FIG. 4. Along with this rotation, conveyor 10 is lifted in the direction indicated by arrow G in FIG. 4. Through the above operations, the position of the wheel of the vehicle placed on conveyor 10 in the up-down direction is changed, and the inclination of the vehicle in the roll direction and the inclination of the vehicle in the pitch direction are corrected.

Note that first moving member 23a and second moving member 23b having reached near each end of linear motion guide 22 as illustrated in FIG. 4 can be returned to the standby positions illustrated in FIG. 3 by applying power to screw member 24 such that screw member 24 is axially rotated in a direction opposite to the direction of arrow B illustrated in FIG. 3. In this manner, first moving member 23a moves in the direction of arrow D illustrated in FIG. 3, and second moving member 23b moves in the direction of arrow C illustrated in FIG. 3 and thus returns to the standby position.

The configuration of correction unit 100 has been described above.

Next, an exemplary correction of the inclination of the vehicle in the yaw direction will be described with reference to FIGS. 5A and 5B. FIG. 5A is a top view schematically illustrating a vehicle before yaw angle correction. FIG. 5B is a top view schematically illustrating the vehicle after the yaw angle correction. Note that for the sake of explanation, control apparatus 300 is not illustrated in FIGS. 5A and 5B.

Correction units 100a to 100d are placed on the ground. Further, correction units 100a to 100d are disposed according to the vehicle type (for example, a light vehicle, a standard vehicle, a small truck, a medium truck, a large truck, and the like). The right front wheel is placed at correction unit 100a, the left front wheel at correction unit 100b, the right rear wheel at correction unit 100c, and the left rear wheel at correction unit 100d.

The positions of bars 17 of correction units 100a to 100d illustrated in FIG. 5A are the standby positions illustrated in FIG. 1. At the standby position, bar 17 is located on the inside of the vehicle wheel.

Motor 26 is a motor that outputs power to power input shaft 30 of each of correction units 100a to 100d. One motor 26 is connected to each power input shaft 30 of correction units 100a to 100d. Thus, it is possible to supply the power of lifter 20 individually to each correction unit 100. Note that motor 26 of each correction unit 100 may be shared by a plurality of correction units 100. In that case, lifters 20 of respective correction units 100 are individually controlled using gears, clutches, or the like that transmit the output of motor 26 to respective correction units 100. Motor 26 corresponds to an example of the second motor.

FIG. 5A illustrates a state in which truck 40 (an example of a vehicle) parked on correction units 100a to 100d illustrated in FIG. 4 is viewed from directly above.

Truck 40 includes right front wheel 41a, left front wheel 41b, right rear wheel 41c, left rear wheel 41d, cab 42, cargo compartment 43, and battery 44. Right front wheel 41a and left front wheel 41b are provided below cab 42, and right rear wheel 41c, left rear wheel 41d, and battery 44 are provided below cargo compartment 43. Right front wheel 41a and left front wheel 41b are single tires, and right rear wheel 41c and left rear wheel 41d are double tires. Note that as described above, right rear wheel 41c and left rear wheel 41d, which are double tires, are each treated as one wheel.

As illustrated in FIG. 5A, right front wheel 41a is placed on correction unit 100a, left front wheel 41b is placed on correction unit 100b, right rear wheel 41c is placed on correction unit 100c, and left rear wheel 41d is placed on correction unit 100d.

In FIG. 5A, straight line X1 is a virtual line that passes through the center of truck 40 in the vehicle width direction and extends in the vehicle length direction. Straight line X2 is a virtual line that extends along a surface facing the right side surface of truck 40 in exchange apparatus 200. Straight line X3 is a virtual line that extends along a surface facing the left side surface of truck 40 in exchange apparatus 200. Here, the distance between straight line X1 and straight line X2 is larger than the distance between straight line X1 and straight line X3. Accordingly, truck 40 illustrated in FIG. 5A is parked in a state of being inclined in the yaw direction.

In the state of FIG. 5A, when motor 16 of each correction unit 100 is driven, bar 17 at the standby position moves in conjunction with the rotation of chain 15 of each correction unit 100 and the movement of moving member 14.

Control apparatus 300 controls motor 16 of correction unit 100a to bring bar 17 into contact with the inside of right front wheel 41a to push it in the direction of arrow I. Further, control apparatus 300 controls motor 16 of correction unit 100d to bring bar 17 into contact with the inside of left rear wheel 41d to push it in the direction of arrow J. This control corrects the inclination of truck 40 in the yaw direction. Further, control apparatus 300 controls each motor 16 of correction units 100a to 100d to control the position of truck 40 in the Y-direction.

By the control described above, the inclination of truck 40 in the yaw direction and the position in the Y direction are corrected. This state is illustrated in FIG. 5B. In FIG. 5B, the distance between straight line X1 and straight line X2 is equal to the distance between straight line X1 and straight line X3, and straight line X1 is parallel to straight lines X2 and X3. Accordingly, in FIG. 5B, truck 40 is in a state in which the distance between the left and right side surfaces thereof and exchange apparatus 200 is kept constant, and is in a position relationship parallel to exchange apparatus 200 in the vehicle length direction.

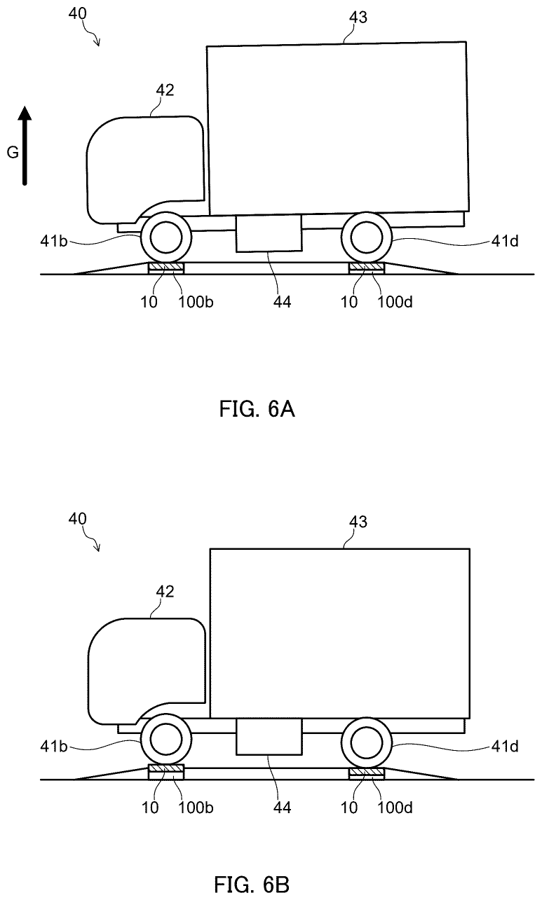

Next, an exemplary correction of the inclination of the vehicle in the pitch direction will be described with reference to FIGS. 6A and 6B. FIG. 6A is a side view schematically illustrating a vehicle before pitch angle correction. FIG. 6B is a side view schematically illustrating the vehicle after the pitch angle correction.

FIG. 6A illustrates a state in which truck 40 illustrated in FIG. 5B is viewed from the side. Truck 40 illustrated in FIG. 6A is inclined in the pitch direction with the front side of the vehicle body lower than the rear side of the vehicle body.

In this case, control apparatus 300 drives motor 26 connected to correction unit 100a and correction unit 100b. As a result, lifter 20 illustrated in FIGS. 3 and 4 operates in each of correction units 100a and 100b. Specifically, in conjunction with the axial rotation of screw member 24, the movement of first moving member 23a and second moving member 23b, and the rotation of each link 25, conveyors 10 of correction units 100a and 100b are lifted in the direction of arrow G. Thus, right front wheel 41a and left front wheel 41b placed at correction units 100a and 100b, respectively, are lifted in the direction of arrow G.

The lift of each conveyor 10 by each lifter 20 corrects the inclination of truck 40 in the pitch direction. This state is illustrated in FIG. 6B. In FIG. 6B, the front of the vehicle body of truck 40 is lifted upward, with the front and rear of the vehicle body kept horizontal.

Next, an exemplary correction of the inclination of the vehicle in the roll direction will be described. When truck 40 illustrated in FIG. 5B is viewed from the front, the vehicle body is inclined in the roll direction with the left side of the vehicle body located lower than the right side of the vehicle body. In this case, motors 26 connected to correction units 100b and 100d illustrated in FIG. 5B are driven. As a result, lifter 20 illustrated in FIGS. 3 and 4 operates in each of correction units 100b and 100d. Specifically, in conjunction with the axial rotation of screw member 24, the movement of first moving member 23a and second moving member 23b, and the rotation of each link 25, conveyors 10 of correction units 100b and 100d are lifted in the direction of arrow G. Thus, left front wheel 41b and left rear wheel 41d, mounted on correction units 100b and 100d, respectively, are lifted in the direction of arrow G.

The lift of each conveyor 10 by each lifter 20 corrects the inclination of truck 40 in the roll direction. At this time, the left side of the vehicle body of truck 40 is lifted upward, with the left side and the right side of the vehicle body kept horizontal.

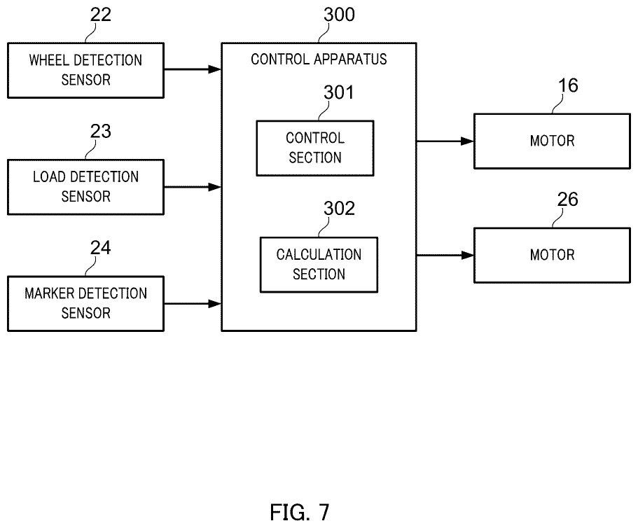

Control apparatus 300 will be described with reference to FIG. 7. FIG. 7 is a block diagram illustrating a configuration of posture correction apparatus 1 including control apparatus 300.

Control apparatus 300 is, for example, a computer disposed in a battery exchange station. Although not illustrated, control apparatus 300 includes, as hardware, for example, a central processing unit (CPU), a read only memory (ROM) that stores a computer program, a random access memory (RAM) that is a work memory, and the like. Each section described below is realized by a CPU executing a computer program read from a ROM in a RAM. Note that control apparatus 300 may be included as a component of correction unit 100.

As illustrated in FIG. 7, control apparatus 300 is electrically connected to each of wheel detection sensor 2, load detection sensor 3, marker detection sensor 4, motor 16, and motor 26.

Wheel detection sensor 2 is provided for each of the plurality of correction units 100. Wheel detection sensor 2 detects whether a wheel is placed on correction unit 100 (specifically, conveyor 10). When wheel detection sensor 2 detects the placement of a wheel, wheel detection sensor 2 outputs the detection result to control apparatus 300.

Load detection sensor 3 is provided for each of the plurality of correction units 100. Load detection sensor 4 detects whether the load (torque value) of motor 16 has become equal to or greater than a defined value after the start of the movement of bar 17. When the load becomes equal to or larger than a defined value, load detection sensor 3 outputs the detection result to control apparatus 300.

Marker detection sensor 4 is, for example, a camera, and captures an image of a marker attached to a predetermined portion of the vehicle (for example, battery 44), and outputs the obtained image to control apparatus 300. The marker detection sensor is provided at a position where the marker can be captured.

The marker is used to detect the inclination of the vehicle in the roll direction and the pitch direction. The marker is attached, for example, to the side surface of the vehicle (a position that is visible when the vehicle is viewed from the side) for the purpose of detecting the inclination in the pitch direction, and to the front surface of the vehicle (a position that is visible when the vehicle is viewed from the front) for the purpose of detecting the inclination in the roll direction.

Note that wheel detection sensor 2, load detection sensor 3, and marker detection sensor 4 may be included in posture correction apparatus 1. Further, wheel detection sensor 2, load detection sensor 3, and marker detection sensor 4 correspond to examples of a first detection apparatus, a second detection apparatus, and a third detection apparatus, respectively.

As illustrated in FIG. 7, control apparatus 300 includes control section 301 and calculation section 302.

When control section 301 receives a detection result indicating that all wheel detection sensors 25 have detected the placement of a wheel, control section 301 drives each motor 16 and starts the movement of each bar 17 at the standby position. At this time, control apparatus 300 drives each motor 16 such that each bar 17 moves at a constant speed.

Subsequently, when control section 301 receives a detection result indicating that the load has become equal to or greater than the specified value from all load detection sensors 26, control section 301 determines that all bars 17 are in contact with the wheel and stops the driving of each motor 16 to stop the constant velocity movement of each bar 17. In this manner, it is possible to correct the inclination in the yaw direction.

After the correction of the inclination in the yaw direction, control section 301 drives motor 26 such that lifter 20 performs the operation of lifting conveyor 10 by the elevation amount (which may be referred to as a lift amount; details are described later) calculated by calculation section 302. In this manner, it is possible to correct the inclination in each of the roll direction and the pitch direction.

Further, when control section 301 receives from exchange apparatus 200 a notification indicating completion of the exchange of battery 44, control section 301 first controls motor 26 to return conveyor 10 to the original position, and then controls motor 16 to return bar 17 to the original position. Thus, the vehicle is set to a ready-to-start state.

Calculation section 302 detects, using a known image analysis technique, the inclined amount (hereinafter, referred to as an inclination amount) of the position of the marker in the image received from marker detection sensor 27 with respect to a predetermined position of the marker. The above-mentioned predetermined position of the marker is the position of the marker when the vehicle is not inclined in either the roll direction or the pitch direction.

Then, calculation section 302 calculates the lift amount for conveyor 10 of each correction unit 100 based on the detected inclination amounts in the roll direction and the pitch direction.

Note that when calculation section 302 detects no inclination amount in both the roll direction and the pitch direction, calculation section 302 does not calculate the lift amount. In this case, the operation of lifter 20 is not performed.

Further, while a case where load detection sensor 26 is used as a means for detecting whether bar 17 is in contact with the wheel has been described above as an example, the present invention is not limited thereto. Instead of load detection sensor 26, a device (for example, a photoelectric sensor, a limit switch, or the like) that is attached to bar 17 and can measure the distance between bar 17 and the wheel may be used.

Further, while the movement of bar 17 is started when the placement of all of the wheels is detected, the present invention is not limited thereto. For example, the movement of bar 17 may be started when the placement of all of the wheels is detected and the ignition off of the vehicle is further detected.

The control apparatus 300 has been described above.

As described above, posture correction apparatus 1 of the present embodiment includes a plurality of correction units 100a to 100b corresponding to a plurality of wheels 41 of vehicle 40, and control apparatus 300 that controls correction units 100a to 100b. Each of correction units 100a to 100b includes conveyor 10 that moves corresponding wheel 41 in the left-right direction of vehicle 40, and lifter 20 that moves conveyor 10 in the up-down direction. Control apparatus 300 at least independently controls the operation of lifter 20 of each of correction units 100a to 100b.

Here, the above-described apparatus disclosed in PTL 1 is designed for a passenger vehicle as the correction target and adopts a method of lifting the bottom surface of the vehicle body with a lifter as the correction method for the roll angle and the pitch angle. If such a method is applied to commercial vehicles (for example, trucks and the like), which have larger weights and higher vehicle body bottom surfaces (the distance from the ground to the vehicle body bottom surface is long) than passenger vehicles, the apparatus size increases, resulting in the need for a large installation space and a longer lifting operation time. Further, in commercial vehicles, various equipment is provided on the bottom surface of the vehicle body (for example, a chassis frame), and as such if the lifter makes contact with the equipment when lifting the vehicle body, the equipment may possibly be damaged.

In contrast, correction unit 100 employs a method of lifting each wheel with a lifter as the correction method for the roll angle and the pitch angle. Thus, the apparatus itself can be made compact, the time required for the lifting operation can be shortened without the need for a large installation space, and the equipment on the bottom surface of the vehicle body is not damaged. In this manner, correction unit 100 can be used not only for passenger vehicles but also for commercial vehicles, and thus a wider range of vehicle types can be supported.

Further, since motor 26 is provided outside conveyor 10 in correction unit 100, it is possible to achieve a low floor (i.e., the height reduction in the height direction) and to achieve size reduction. Thus, it is possible to reduce the installation area of the battery exchange station and to reduce the construction cost without the need to dig a pit for correction unit 100 or to install a large-scale raising slope.

The present disclosure is not limited to the description of the above-described embodiments, and various modifications can be made within the scope not departing from the concept of the present disclosure.

### INDUSTRIAL APPLICABILITY

The correction unit of the present disclosure is useful, for example, in a technology for correcting the posture of a vehicle parked at a battery exchange station or the like.

### REFERENCE SIGNS LIST

10 Conveyor
11 Roller
12 Side surface member
13 Linear motion guide (for moving member)
14 Moving member
15 Chain
16 Motor
17 Bar
20 Lifter
21 Bottom surface member
22 Linear motion guide (for wheel part)
23a First moving member
23b Second moving member
231 Wheel part
232 Support part
233 Nut part
24 Screw member
25 Link
30 Power input shaft
26 Motor
40 Truck
41a Right front wheel
41b Left front wheel
41c Right rear wheel
41d Left rear wheel
42 Cab
43 Cargo compartment
44 Battery
45 Wheel detection sensor
46 Load detection sensor
47 Marker detection sensor
100 Correction unit
200 Exchange apparatus
300 Control apparatus
301 Control section
302 Calculation section

1. A posture correction apparatus comprising:
a plurality of correction units corresponding to a plurality of wheels of a vehicle; and
a control apparatus that controls the correction units,
wherein the correction units includes:
a conveyor that moves a corresponding wheel in a left-right direction of the vehicle, and
a lifter that moves the conveyor in an up-down direction, and
wherein the control apparatus independently controls at least an operation of the lifter of each correction unit.

2. The posture correction apparatus according to claim 1, wherein the conveyor includes:
a plurality of rollers that rotate in the left-right direction of the vehicle,
a pushing member that moves on an upper side of the plurality of rollers, and
a first motor that moves the pushing member in a direction in which the rollers rotate.

3. The posture correction apparatus according to claim 2,
wherein the lifter includes a second motor for lifting the conveyor, and
wherein the control apparatus individually controls the first motor and the second motor.

4. The posture correction apparatus according to claim 3, further comprising a first detection apparatus that detects placement of the wheel on the conveyor,
wherein when the first detection apparatus detects that all of the plurality of wheels are placed on the conveyor of the plurality of correction units, the control apparatus controls the first motor of the conveyor to start movement of the pushing member.

5. The posture correction apparatus according to claim 4, further comprising a second detection apparatus that detects a load applied to the first motor,
wherein when the second detection apparatus detects that the load applied to all of the first motors in the plurality of correction units is equal to or greater than a threshold after movement of the pushing member is started, the control apparatus controls the first motor to stop the movement of the pushing member.

6. The posture correction apparatus according to claim 5, wherein the control apparatus starts control of the lifter after stopping the movement of the pushing members of all of the conveyors of the plurality of correction units.

7. The posture correction apparatus according to claim 6, further comprising a third detection apparatus that detects an inclination of the vehicle,
wherein the control apparatus controls each of the lifters of the plurality of correction units in accordance with the inclination.
